(19) United States
(12) Patent Application Publication
(10) Pub. No.: US 2014/0305524 A1
(43) Pub. Date: Oct. 16, 2014

(54) Thermal Insulation Having An RFID Device

(71) Applicants: Craig Heizer, Belleville (CA); John Crager, Dallas, TX (US)

(72) Inventors: Craig Heizer, Belleville (CA); John Crager, Dallas, TX (US)

(21) Appl. No.: 14/250,283

(22) Filed: Apr. 10, 2014

Related U.S. Application Data
(60) Provisional application No. 61/810,427, filed on Apr. 10, 2013.

(51) Int. Cl. F17D 5/00

(52) U.S. Cl. CPC F17D 5/00
USPC 137/551

(57) ABSTRACT

An insulation device for maintaining temperature of a process fluid equipment includes insulation material positioned on the process equipment and at least one RFID device located on or in the insulation material. Each RFID device can provide one or more functions such as identification of a blanket and monitoring of one or more parameters, such as environmental, mechanical, electrical, and operational parameters and conditions on piping, tanks, vessels and related process equipment. Information transmitted by the RFID device can be processed to provide temperature sensing, leak detection, a data logging/export function, and other functions. Operators of the process fluid equipment can use the RFID device information to monitor the system status and take corrective action if needed.

### CROSS-REFERENCE TO RELATED APPLICATIONS

This is a non-provisional application and claims the benefit of U.S. Provisional Pat. App. Ser. No. 61/810,427, filed Apr. 10, 2013, and incorporated herein by reference.

### BACKGROUND

It is frequently desirable that a process fluid, such as water, oil, liquid sulfur, and the like, flowing within process equipment such as pipes, valves and other equipment, or fluid stored in a container, be maintained at a selected temperature elevated above the ambient temperature. In order to maintain the selected temperature, portions of the process equipment are wrapped in thermal insulation in order to reduce the amount of heat transfer and to increase the amount of time before the process fluid freezes or cools to an undesirable level. If a proper temperature is not maintained, the process equipment or the fluid therein may become damaged or inoperable. For example, a frozen valve may occur which is costly in terms of downtime, repair and loss of production.

The insulation may be in the form of an insulation blanket. In use, an insulation blanket may be wrapped around a valve, for example, through the use of various attachment methods that enable frequent installation and removal of the blanket. Over time however, frequent installation and removal of the blanket may wear out or damage the blanket or compress the insulation, thus compromising the insulation properties and effectiveness of the blanket. In addition, a worn out or damaged blanket increases the potential for air or moisture ingress in the blanket interior, thus further decreasing the insulation properties and effectiveness of the blanket. It would be desirable to monitor the location and condition of the blanket in order to replace or repair the blanket before its effectiveness is substantially decreased or compromised.

In addition, blankets typically include plastic or metal tags that visually identify the blanket to operators. The tags can be damaged, become unreadable or may unknowingly become detached from a blanket during use, thus making identification of the blanket difficult. Therefore, it would also be desirable for an operator to be able to readily identify an individual blanket within a distributed system of blankets in an industrial or other facility.

### SUMMARY

An insulating device for maintaining temperature of a process fluid in process equipment is disclosed. The insulating device includes insulating material (i.e., insulation) positioned on the process equipment and at least one RFID device located on or in the insulation. In one embodiment, each RFID device provides a single function such as either identification of a blanket, temperature sensing, leak detection or a data logging/export function. Alternatively, a combined RFID device can be used that provides multiple functions.

In an embodiment according to the disclosure, the insulating device can include insulation configured to cover a component of process equipment and maintaining temperature of a process fluid in the component, and at least one RFID device attached to the insulation and configured to transmit information about the insulation to a reader. The RFID device can provide identifying information and/or environmental information for the insulation. The environmental information can include a temperature of the component, a temperature of the insulation, or a humidity level. The RFID device can log the environmental information.

At least one of the RFID devices is attached to an outer surface of the insulation. The insulating device can further include lacing wire for securing the insulation to the component. The lacing wire can secure one or more of the RFID devices to the outer surface of the insulation. The insulating device can further include a pocket attached to the outer surface of the insulation and containing at least one of the RFID devices. At least one of the RFID devices is attached to an inner surface of the insulation, the inner surface contacting the component.

The insulation can be an insulation blanket having an outer layer, an inner layer positioned adjacent to the component, and an insulation layer between the outer layer and the inner layer. A first of the RFID devices can be attached to the outer layer and a second of the RFID devices can be attached to the inner layer.

Another embodiment of the present disclosure provides a system for maintaining temperature of a process fluid in one or more components of process equipment. The system can include one or more insulating devices insulating each component. Each insulating device can include insulation and at least one RFID device attached to the insulation and configured to transmit information about the insulation. The system can further include a reader configured to receive the information from each RFID device, and at least one processor in electrical communication with the reader and configured to read the information and determine the status of one or more parameters of the insulation. The information can include a temperature of the component, and determining the status of the one or more parameters of the insulation can include comparing the temperature of the component to a specified range. The processor can be configured to generate one or more of: a low temperature alarm if the temperature of the component is below the specified range; and, a high temperature alarm if the temperature of the component is above the specified range. The insulation can be a blanket comprising an outer layer, an inner layer adjacent to the respective component, and an insulation layer between the outer layer and the inner layer, at least one of the RFID devices being positioned on either the outer layer or the inner layer.

Another embodiment of the present disclosure provides a method of maintaining temperature of a process fluid in a component of process equipment. The method can include: insulating the component with an insulating device comprising insulation and at least one RFID device attached to the insulation and configured to transmit information about the insulation to a reader; receiving, on an electronic reader, information about the insulation from the RFID device; and, if the information indicates that the insulation is damaged or defective, repairing or replacing the insulating device. The information can include a temperature of one or more of the insulation, the component, and the component's surrounding area; the insulation is damaged or defective if the temperature included in the information is outside a specified range. The RFID device can be configured to signal a high temperature alarm if the temperature of the insulation exceeds a safe limit. The information can include a humidity level; the insulation is damaged or defective if the humidity level is outside a specified range.

### DESCRIPTION OF THE DRAWINGS

FIG. 1 is a perspective view of an insulating device in accordance with the present disclosure wrapped around a section of a pipe.

FIG. 2 is a flowchart of a method for maintaining temperature of a component in a process system in accordance with the present disclosure.

FIG. 3 is a partial cross section of the insulating device of FIG. 1.

FIG. 4 is a perspective view of an inner surface of the insulating device.

FIG. 5 is a perspective view of an inner surface of an insulation blanket.

### DETAILED DESCRIPTION

Before any embodiments of the invention are explained in detail, it is to be understood that the invention is not limited in its application to the details of the construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

In addition, the terms “computer”, “computer system”, or “server” as used herein should be broadly construed to include any device capable of receiving, transmitting and/or using information including, without limitation, a processor, microprocessor or similar device, a personal computer, such as a laptop, palm PC, desktop, workstation, or word processor, a network server, a mainframe, an electronic wired or wireless device having memory and a storage device, such as for example, a telephone, and interactive, television, such as for example, a television adapted to be connected to the Internet or an electronic device adapted for use with a television, a cellular telephone, a personal digital assistant, an electronic pager, a digital watch and the like. Further, a computer, computer system, or system of this embodiment can operate in communication with other systems over a communication network, such as, for example, the Internet, an intranet, or an extranet, or can operate as a stand-alone system, virtual private network, and any other internetworked system.

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives and fall within the scope of embodiments of the invention.

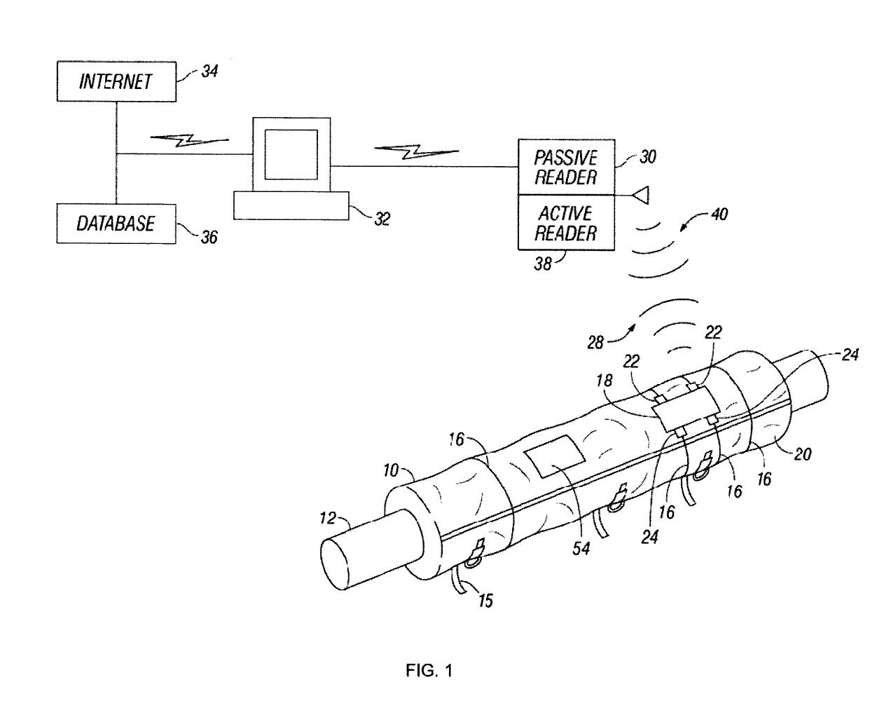

Referring to FIG. 1, thermal insulation 10 in accordance with the present invention is shown positioned around a section of a pipe 12 used to convey a process fluid for an industrial process. The insulation 10 can be in the form of a batt, preform, foam, blanket, insulation paint, tape and other forms. The insulation 10 is fabricated from, for example, fiberglass or any other commercially available insulation material. Although a pipe is shown, it is understood that the insulation 10 can be also used on valves, tanks, vessels and other process equipment which include the process fluid. In FIG. 1, the insulation 10 is shown wrapped around the pipe 12. Edges 14 of the insulation 10 can be secured together to tightly wrap the insulation 10 and attach the insulation 10 to the pipe 12. By way of example, the edges 14 can be fastened by snaps, hook and loop fasteners such as VELCRO® brand Hook and Loop Fasteners, straps, tape, adhesive or lacing wire and combination thereof. FIG. 1 depicts the use of straps 15 and lacing wire 16 to secure the insulation 10 to the pipe 12.

One or more electronic wireless sensor devices, such as a radio frequency identification (RFID) device 18, can be attached to an outer surface 20 of the insulation 10. The RFID device 18 can include upper eyelets 22 and lower eyelets 24 for attaching the RFID device 18 to the insulation 10. In some embodiments, the lacing wire 16 or another wire or cord can be threaded through the eyelets 22, 24 in order to attach the RFID device 18 to the outer surface 20. In an embodiment, the lacing wire 16 also serves to attach the insulation 10 to the pipe 12. Alternatively, the RFID device 18 can be attached to the outer surface 20 by using an adhesive or other non-adhesive fastening method. Additionally or alternatively, the insulation 10 can include a pocket 54 for holding the RFID device 18 on the outer surface 20. More than one RFID device 18 can be attached to the outer surface 20.

The RFID device 18 can be of the active or passive type, although other types can be used. An active RFID device 18 is powered by its own power supply and can include an integrated circuit, a transmitter and a battery or other power source to wirelessly transmit a signal 28 that includes information about the insulation 10 to an RFID reader, such as a passive reader 30. A passive RFID device 18 does not include a battery and is used in conjunction with an active reader 38. A passive device 18 uses radio energy 40 transmitted by the active reader 38 as its energy source. Another type of RFID device that can be used is a battery assisted RFID device 18. In a battery assisted RFID device 18, a smaller battery is used and the RFID device 18 is only activated in the presence of an active reader 38. The RFID device 18 can be configured to transmit information over various frequencies and distances.

A reader 30, 38 can be fixed, mobile or hand held and can be configured to create a specific interrogation zone. In some embodiments, the reader 30, 38 can receive the signal 28 from the RFID device 18 and can transmit the information either wirelessly or over a network to a computer system 32 running RFID software or RFID middleware, for example, to process and store information in a database. In other embodiments, the reader 30, 38 can be integrated within the computer system 32. The computer system 32 can be connected either wirelessly over a network to the internet 34 for access to other resources such as servers or databases, for example, or directly to a database 36 that is part of a local network. The computer system 32 can process information transmitted from the RFID 18 as described below, and can transmit processed or raw information to other computer systems via any suitable communication network to other computers, servers, and the like, for further processing, storage, or display. The computer system 32 can also transmit information, queries, and other data back to the readers 30, 38 if the latter are remote units.

In an embodiment, the information transmitted by the RFID device 18 includes identifying information such as an identification number, location information, installation data and other information regarding the insulation 10. Additionally or alternatively, the RFID device 18 can include one or more sensors for detecting parameters such as temperature, pressure, humidity, strain, vibration, and other parameters that may be relevant to determining the status of the insulation 10, the insulated component (i.e., pipe, valve, and the like), the process fluid contained or flowing therein, or other environmental conditions. In other embodiments, discrete sensors can be placed on surfaces or within the insulation 10 and can be configured to communicate sensed parameters, as described herein, to the RFID device 18. Suitable RFID devices 18 and sensors include those commercially available and sold by Phase IV Engineering, Inc. in Boulder, Colo., USA, for example.

In some embodiments, the RFID device 18 can include a temperature sensor to detect the temperature of the insulation 10. The temperature of the insulation 10 may be indicative of the temperature of the pipe 12 or of the surrounding environment, depending on the position of the RFID device 18 on the insulation 10. Over time, the insulation 10 may wear out or become damaged, or may have been incorrectly installed, thus compromising the insulation properties and effectiveness of the insulation 10. A deviation of the temperature sensed by the RFID device 18 from an expected temperature may indicate failure of the insulation 10, high or low temperature of the insulated component, or unusual conditions in the surrounding area (e.g. fire or excessive cold air). In some embodiments, the RFID device 18 can continuously or periodically transmit temperature data via the signal 28, which can be processed by the reader 30, 38 or the computer system 32 to generate a temperature alarm if the temperature is outside a specified “normal” range. In other embodiments, the RFID device 18 can itself be programmed with a specified temperature range, and can be configured to detect a deviation from that range, such as that the insulation 10 is at an undesirable low temperature indicating that the pipe 12 is at a temperature that may cause a valve to freeze or a process fluid within the pipe 12 to become too viscous or freeze. Upon such detection, the RFID device 18 can transmit an alarm signal to the reader 30, 38. The alarm signal can be transmitted a preset number of times, or periodically at a predetermined interval, or continuously until the temperature returns to normal or the RFID device 18 is reset.

In addition, worn out, damaged or incorrectly installed insulation 10 increases the potential for air or moisture ingress into the insulation interior, this further decreasing the insulation properties and effectiveness of the insulation. The RFID device 18 can include a humidity sensor to detect moisture within the insulation 10 which would ultimately compromise the insulation properties of the insulation 10. The moisture may indicate that the insulation 10 is failing, or the moisture may be caused by unusual conditions, such as a leak in the process equipment. The RFID device 18 can be configured to report the humidity level of the insulation 10 as described above with respect to the temperature data reporting.

If there is a pipe freeze or other impediment to fluid flow, pressure can build in the system and cause significant damage. This pressure may be first detectable at weaker points in the system, such as valve and pipe joints that may be covered by the insulation 10. Thus, in some embodiments, the RFID device 18 can include a stress, pressure, or vibration sensor that can detect bending, twisting, expansion, contraction, or other undesirable movement in the insulated component. The RFID device 18 can be configured to report the movement as described above with respect to the temperature data reporting.

The RFID device 18 can also or alternatively record and log specific data regarding the parameter being detected, such as temperature, which can be exported (i.e., transmitted) for various types of analysis such as fault analysis. In such embodiments, the RFID device 18 can include memory or other data storage capability in order to retain a suitable amount of parameter records to achieve a desired function. For example, the RFID device 18 can retain a temperature history of the insulating device spanning a predetermined period (e.g., two weeks, two months, two years, etc.). The RFID device 18 can transmit the temperature history and, in turn, the reader 30, 38 or a computer (e.g., computer system 32) can analyze the temperature history to obtain periodic or historic performance information about the insulation 10 or the component it is insulating. Alternatively, the RFID device 18 can include a processor having sufficient processing power to perform some analysis, such as determination of periodic or historic performance information, of the temperature history it collects. In the same manner, the RFID device 18 can collect, store, analyze, and/or transmit any other parameter according to the configuration of the RFID device 18.

Many types of performance information can be obtained by an insulation monitoring system in accordance with this disclosure, depending on the processing power of the processor(s) performing the analysis, the parameters, values, and time frame being analyzed, the number and position of RFID devices 18 providing data for analysis, and the goals of the analysis. The system can thus operate on one or more of several levels of device integration, analyzing the data output of a single RFID device 18 on one insulating device, a single RFID device 18 on all or a subset of the insulating devices in the system, multiple RFID devices 18 on a single insulating device, or some or all RFID devices 18 on each or a subset of the insulating devices in the system. In this manner, the presently disclosed insulating devices and the monitoring system that employs them can monitor the position, current operating parameters, and historical performance of the insulation system as a whole or in any suitable partition. Such configurations can provide operators with a pro-active indication of the status of the system, which enables the owner to prevent or correct an impending issue before a costly failure occurs.

In some embodiments, periodic or historic performance information for temperatures of one or more insulating devices in the system can include temperature trends that, in non-limiting examples, identify: the temperature range of the insulated component in normal conditions; efficiency of the insulation 10 (e.g., degree change of a pipe as reported by a first RFID device 18 on the inner surface of a blanket, compared against degree change of the surrounding environment reported by a second RFID device 18 on the outer surface of the blanket, monitored over time); periodic temperature peaks or valleys that can be correlated to a problem or occurrence in the pipe system; and, performance information as compared to other insulating devices in an insulation system. For example, the system can identify that a temperature rise occurs at the same time every Monday as an introduction into the pipe system of a “hot shot” of viscosity-reducing liquid, and can reconfigure the system high-temperature alarming to ignore this weekly temperature peak as normal operation. In another example, the system can obtain and store historic temperature profiles for thermally aged insulation 10. Such temperature profiles can illustrate the progression of certain types of insulation 10 toward failure at the end of their useful lives. The system can then compare temperature trends of deployed insulating devices to the appropriate temperature profiles in order to predict and warn when the insulating devices are reaching their points of failure.

In another embodiment, the RFID device 18 can be a combined RFID device that provides identification, temperature sensing, leak detection and data logging/export functions. Further, although the current invention is described in connection with the use of wireless devices, it is noted that wired electronic devices can be used instead of, or in combination with, RFID devices 18.

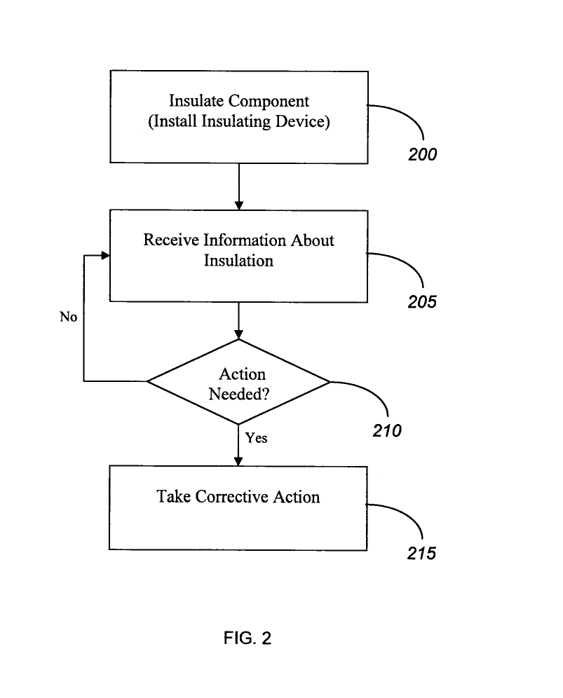

Referring to FIG. 2, the present system and insulating devices may be used to maintain temperature of the components of the process equipment. For each component to be maintained, at step 200 the component can be insulated may installing an insulating device of the present disclosure thereon. For example, an RFID device-equipped insulating blanket may be wrapped and fastened around the component. At step 205, information about the insulation 10 transmitted by the RFID device 18 can be received. At step 210, the information may be reviewed or analyzed to determine if action is needed. The action to be taken may depend on the parameter that is reporting an abnormal value. For example, if any recorded parameter is outside of its specified range, at step 215 a corrective action may be taken according to the information reported by the RFID device 18. If the information indicates that the insulation 10 or another aspect of the insulating device is damaged, the corrective action can include repair or replacement of the insulating device. In other embodiments, the information may indicate a problem with another component of a heating system, such as the heating cable, and the corrective action may pertain to repair or replacement of the component.

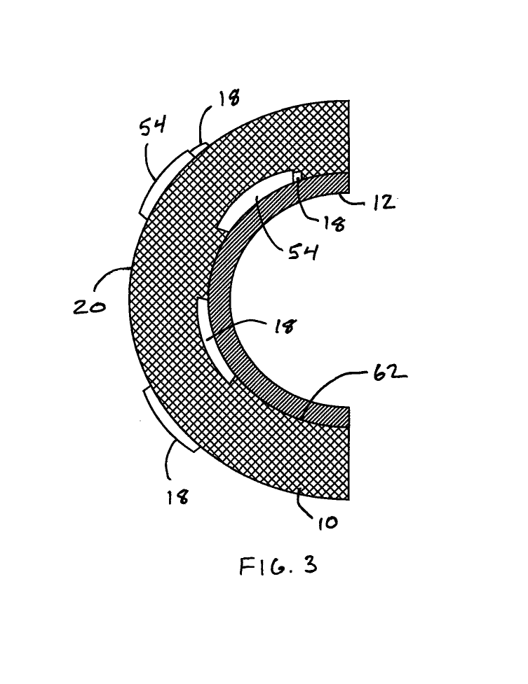

Referring to FIG. 3, a partial cross section view of the insulation 10 of FIG. 1 surrounding a pipe 12 is shown. An inner surface 62 of the insulation 10 is located adjacent to, or in contact with, the pipe 12. The inner surface 62 can include a pocket 54 or another fastening mechanism for holding one or more RFID devices 18 directly to the inner 62 and outer 20 surfaces. In another embodiment, a plurality of RFID devices 18 can be used on either the inner 62 or outer 20 surfaces or both the inner surface 62 and outer 20 surface, wherein each RFID device provides a single function or multiple functions. For example, identification, temperature sensing, leak detection and data logging/export function would be provided by separate RFID devices 18. In another example, a first RFID device 18 on the inner surface 62 can be configured to detect the temperature of the pipe 12, and a second RFID device 18 on the outer surface 20 can be configured to detect the temperature of the insulation 10 or the environment. In yet another embodiment, one or more of the RFID devices 18 can be located anywhere in the insulation 10 between the inner surface 62 and outer 20 surface for detecting conditions (e.g., temperature or moisture) within the insulation 10. A recess 64 can be formed in the inner surface 62 or the outer surface 20 for accommodating either the pocket 54 or direct attachment of an RFID device 18.

The insulation properties of the insulation 10 can also be used for personnel protection. In particular, the insulation 10 insulates the pipe or equipment so that the surface temperature is not hazardous to the touch for maintenance personnel or operators. In this case, an RFID sensor 18 positioned on the outer surface 20 would signal a high temperature alarm, rather than a low temperature alarm, to warn operators that the temperature at the surface of the insulation 10 exceeds safe health and safety limits.

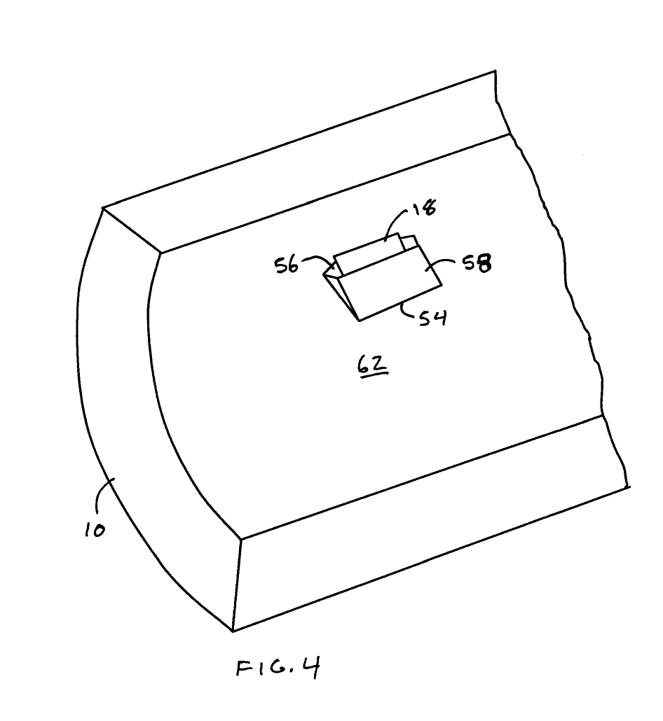

Referring to FIG. 4, a perspective view of the inner surface 62 of the insulation 10 is shown. As previously described, in use the inner surface 62 can be located adjacent to, or in contact with, the pipe 12. The inner surface 62 includes a pouch or pocket 54 having an opening 56 for receiving one or more RFID devices 18, thus positioning the RFID devices 18 adjacent to the pipe 12. The opening 56 can be closed with hook and loop fasteners such as VELCRO® brand Hook and Loop Fasteners, for example. A wall 58 of the pocket 54 can be fabricated from a material that does not substantially interfere with the sensing capability of the RFID devices 18. Alternatively, the wall 58 can be fabricated from a mesh material that provides air passageways to facilitate detection of environmental conditions.

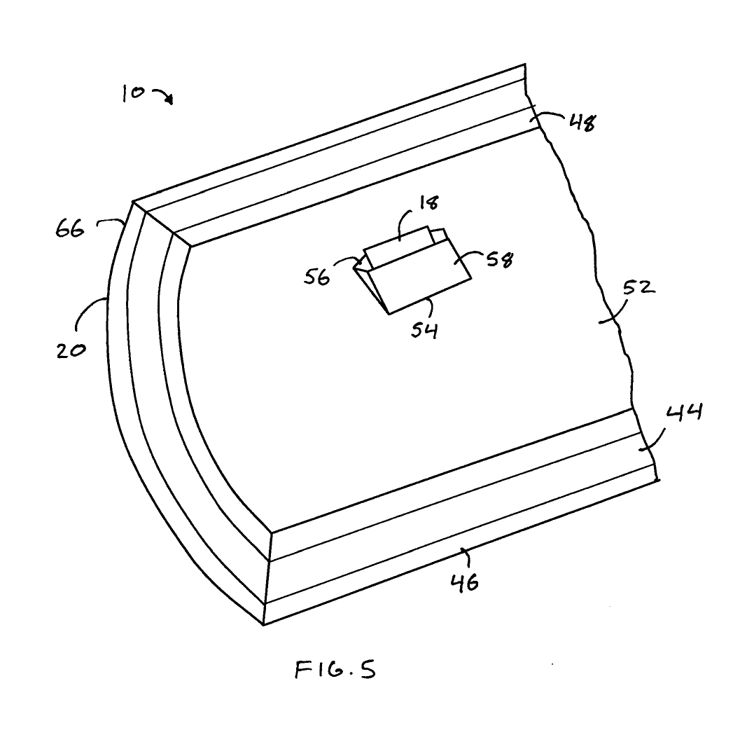

In an embodiment, the insulation 10 is in the form of an insulation blanket. Referring to FIG. 5, a partial cross sectional view of an insulation blanket 66 is shown. The blanket 66 includes an insulation layer 44 located between a protective cover layer 46 and an inner liner 48. The protective cover layer 46 provides a level of protection for the insulation layer 44 from the environment in which the blanket 66 is located. The protective cover layer 46 can be fabricated from fiberglass which has been coated with a polytetrafluoroethylene (PTFE) protective coating such as TEFLON® brand protective coating. The insulation layer 44 can include an insulation mat fabricated from open and closed cell insulations such as fiberglass, mineral wool, STYROFOAM® brand insulation, neoprene, polyisocyanurate, various nano insulations such as aerogel, or specialized insulations such as vacuum insulated panels (VIPs) and others. The inner layer 48 can be fabricated from fiberglass or steel mesh depending on the expected operating temperature. The inner layer 48 can also serve as a barrier to protect the insulation layer 44 from seepage. It is noted that other materials suitable for an insulation blanket can be used depending on the environment, operating temperature in which the blanket 66 will be used and other operational parameters. Further, there could be multiple types of insulation or more than one layer of insulation material and combinations thereof in the blanket 66. In use, an inner surface 52 of the blanket 66 is located adjacent to, or is on contact with, the pipe 12. The inner surface 52 includes the pocket 54 as previously described in relation to FIG. 3.

Thus, the current invention provides an improved technique for identifying the blanket and associated information. Further, the current invention provides a blanket that detects environmental information regarding the blanket such as temperature, moisture, geo-spatial location, alphanumeric tagging, service history such as date of last inspection, and others. The current invention also provides a blanket that communicates identification and sensor information wirelessly and logs temperature and other parameters for proactive maintenance purposes and fault analysis.

While the invention has been described in conjunction with specific embodiments, it is evident that many alternatives, modifications, permutations and variation will become apparent to this skilled in the art in light of the foregoing description. Accordingly, it is intended that the present invention embrace all such alternatives, modifications and variation.

1. An insulating device comprising:
insulation configured to cover a component of process equipment, the insulation maintaining temperature of a process fluid in the component; and
at least one RFID device attached to the insulation and configured to transmit information about the insulation to a reader.

2. The insulating device of claim 1, wherein the RFID device provides identifying information for the insulation.

3. The insulating device of claim 1, wherein the RFID device provides environmental information for the insulation.

4. The insulating device of claim 3, wherein the environmental information comprises a temperature of the component.

5. The insulating device of claim 3, wherein the environmental information comprises a temperature of the insulation.

6. The insulating device of claim 3, wherein the environmental information comprises a humidity level.

7. The insulating device of claim 3, wherein the RFID device logs the environmental information.

8. The insulating device of claim 1, wherein at least one of the RFID devices is attached to an outer surface of the insulation.

9. The insulating device of claim 8, further comprising lacing wire for securing the insulation to the component, the lacing wire securing one or more of the RFID devices to the outer surface of the insulation.

10. The insulating device of claim 8, further comprising a pocket attached to the outer surface of the insulation and containing at least one of the RFID devices.

11. The insulating device of claim 1, wherein at least one of the RFID devices is attached to an inner surface of the insulation, the inner surface contacting the component.

12. The insulating device of claim 1, wherein the insulation comprises an insulation blanket having an outer layer, an inner layer positioned adjacent the component, and an insulation layer between the outer layer and the inner layer.

13. The insulating device of claim 12, wherein a first of the RFID devices is attached to the outer layer and a second of the RFID devices is attached to the inner layer.

14. A system for maintaining temperature of a process fluid in one or more components of process equipment, the system comprising:
one or more insulating devices insulating each component, each insulating device comprising insulation and at least one RFID device attached to the insulation and configured to transmit information about the insulation;
a reader configured to receive the information from each RFID device; and
at least one processor in electrical communication with the reader and configured to read the information and determine the status of one or more parameters of the insulation.

15. The system of claim 14, wherein the information comprises a temperature of the component, and wherein determining the status of the one or more parameters of the insulation comprises comparing the temperature of the component to a specified range, the processor being further configured to generate one or more of:
a low temperature alarm if the temperature of the component is below the specified range; and
a high temperature alarm if the temperature of the component is above the specified range.

16. The system of claim 15, wherein the insulation is a blanket comprising an outer layer, an inner layer adjacent to the respective component, and an insulation layer between the outer layer and the inner layer, at least one of the RFID devices being positioned on either the outer layer or the inner layer.

17. A method of maintaining temperature of a process fluid in a component of process equipment, the method comprising:
insulating the component with an insulating device comprising insulation and at least one RFID device attached to the insulation and configured to transmit information about the insulation to a reader;
receiving, on an electronic reader, information about the insulation from the RFID device; and
if the information indicates that the insulation is damaged or defective, repairing or replacing the insulating device.

18. The method of claim 17, wherein the information includes a temperature of one or more of the insulation, the component, and the component's surrounding area, and wherein the insulation is damaged or defective if the temperature included in the information is outside a specified range.

19. The method of claim 18, wherein the RFID device is configured to signal a high temperature alarm if the temperature of the insulation exceeds a safe limit.

20. The method of claim 17, wherein the information includes a humidity level, and wherein the insulation is damaged or defective if the humidity level is outside a specified range.
